(19) United States
(12) Patent Application Publication
(10) Pub. No.: US 2024/0228319 A1
(43) Pub. Date: Jul. 11, 2024

(54) METHOD FOR PREPARING POLYANION TYPE SODIUM BATTERY POSITIVE ELECTRODE MATERIAL ON THE BASIS OF ORGANIC ACID DISSOLUTION METHOD

(71) Applicant: SHENZHEN JANAENERGY TECHNOLOGY CO., LTD., SHENZHEN (CN)

(72) Inventors: YULIANG CAO, SHENZHEN (CN); ALONG ZHAO, SHENZHEN (CN); XINPING AI, SHENZHEN (CN); HANXI YANG, SHENZHEN (CN)

(21) Appl. No.: 18/430,927

(22) Filed: Feb. 2, 2024

Related U.S. Application Data
(63) Continuation of application No. PCT/CN2022/106742, filed on Jul. 20, 2022.

(30) Foreign Application Priority Data
Aug. 27, 2021 (CN) 202110992430.6

(51) Int. Cl. C01G 49/00; H01M 4/02; H01M 4/58

(52) U.S. Cl. CPC C01G 49/009; H01M 4/5825; C01P 2004/03; C01P 2006/40; H01M 2004/028

(57) ABSTRACT

The present invention provides a method for preparing a polyanion type sodium battery positive electrode material on the basis of an organic acid dissolution method, comprising the following steps: step S1: preparing a mixture of a transition metal source, a sodium source, and a polyanion source, and putting the mixture into a reactor, the transition metal source being a transition metal simple substance or a transition metal oxide; step S2, adding organic acid into the reactor, heating, and continuously stirring until the transition metal source is completely dissolved; step S3, adding a carbon source, stirring, and drying to obtain precursor powder; and step S4, heating the precursor powder in an inert gas atmosphere, and after the heating treatment is completed, cooling the precursor powder to room temperature along with a furnace to obtain the polyanion type sodium battery positive electrode material.

### TECHNOLOGY FIELD

The present invention belongs to the technical field of sodium ion battery materials, and particularly relates to a method for preparing a polyanion type sodium battery positive electrode material on the basis of an organic acid dissolution method.

### BACKGROUND

In recent years, the environmental pollution caused by the extensive use of fossil fuels has attracted more attention, making the development of clean energy sources, such as solar, wind and hydroelectric power, become a hot topic. However, affected by geographical location, seasons, weather and other factors, the clean energy sources have the shortcomings of high volatility and unsustainable supply, etc., therefore, large-scale energy storage and conversion devices are required to achieve reasonable allocation and regulation of the clean energy sources. Among the existing energy storage technologies, pumped-water energy storage, compressed-air energy storage, flywheel energy storage, and supercapacitor energy storage are mostly limited by energy density, geographical location and technological bottlenecks, preventing large-scale utilization. Secondary batteries, due to their comprehensive advantages such as mature technology, high flexibility and high energy conversion rate, have become an ideal choice for large-scale energy storage technology. Secondary batteries include, among others, silver-hydrogen batteries, silver-cadmium batteries, lead-acid batteries, alkaline zinc-manganese batteries, lithium-ion batteries, sodium-ion batteries, and potassium-ion batteries. However, lithium/sodium-ion batteries undoubtedly stand out as the outstanding ones in terms of technology maturity, total system cost, energy/power density and environmental adaptability. Although the lithium-ion batteries dominate the current 3C product market and the field of electric vehicles, the scarcity and uneven distribution of lithium resources will be inevitably unable to meet the growing demands of the field of electric vehicles, let alone the requirements of large-scale energy storage at a low cost. Sodium-ion batteries, working on the principles similar to those of the lithium-ion batteries, have the advantages of more abundant and widely distributed sodium resources, and lower costs for relevant electrode materials, making them become a focus in the field of large-scale energy storage at present.

There are various types of positive electrode materials for sodium-ion batteries, including oxides, Prussian blue, and polyanion-type materials. However, polyanion type sodium battery positive electrode material is undoubtedly the best choice in terms of resource abundance, overall material cost, electrochemical performance and environmental sustainability.

### SUMMARY

In view of the problems existing in the prior art, the present invention provides a method for preparing a polyanion type sodium battery positive electrode material on the basis of an organic acid dissolution method.

In order to solve the above technical problems, the present invention adopts the following technical solution:
a method for preparing a polyanion type sodium battery positive electrode material on the basis of an organic acid dissolution method, including the following steps:
step S1: preparing a mixture of a transition metal source, a sodium source, and a polyanion source, and putting the mixture into a reactor, the transition metal source being a transition metal simple substance or a transition metal oxide;
step S2: adding organic acid into the reactor, heating, and continuously stirring until the transition metal source is completely dissolved; and adding sufficient or excess organic acid to have the transition metal source completely dissolved;
step S3: adding a carbon source, stirring, and drying to obtain precursor powder; and
step S4: heating the precursor powder in an inert gas atmosphere, and after the heating treatment is completed, cooling the precursor powder to room temperature along with a furnace to obtain the polyanion type sodium battery positive electrode material.

Further, the transition metal source is V, Ti, Mn, Fe, Co, Ni, Cu, Zn or oxides thereof.

Further, the sodium source is one or more of sodium nitrate, sodium carbonate, sodium phosphate, sodium dihydrogen phosphate, sodium formate, sodium acetate, sodium oxalate, sodium citrate and sodium metal.

Further, the polyanion source is one or more of phosphorus simple substance, phosphoric acid, pyrophosphoric acid, sodium phosphate, sodium dihydrogen phosphate, boron simple substance, boric acid, sodium borate, silicon simple substance, silicic acid and sodium silicate.

Further, the organic acid includes one or more of formic acid, acetic acid and oxalic acid.

Further, usage amounts of the transition metal source, the sodium source and the polyanion source comply with the stoichiometric ratio in the chemical formula of the prepared polyanion type sodium battery positive electrode material, a usage amount of the organic acid is 1-5 times of the molar amount of the added transition metal source, and a usage amount of the carbon source is 1-3 times of the molar amount of the added transition metal source.

Further, in the step S2, a heating temperature is 90° C.

Further, the carbon source is one or more of graphene, carbon nanotubes, graphite, carbon powder, citric acid, glucose and sucrose.

Further, in the step S4, the inert gas atmosphere is argon, nitrogen, argon-hydrogen mixed gas, or nitrogen-hydrogen mixed gas.

Further, in the step S4, the heating treatment process is as follows: a temperature is increased to 200° C.-300° C. at a heating rate of 2-5° C./min and then maintained for 3 h; and the temperature is further increased to 400° C.-550° C. at a heating rate of 2° C./min and then maintained for 10 h.

Further, in the step S3, the drying method is freeze drying, air-blowing drying, spray drying or vacuum drying.

Compared with the prior art, the present invention has the following beneficial effects:

1. A mixed solution obtained after the organic acid is dissolved is uniform in ion distribution, dried precursor particles are small, crushing treatment is not needed, and a corresponding electrode material can be directly prepared by means of high-temperature calcination.

2. The organic acids can be used to dissolve the transition metal simple substances or their oxides, so that flammable gas H₂ can be collected, and the use of expensive transition metal compounds can be avoided, thereby indirectly avoiding environmental pollution by waste during the synthesis of transition metal compounds.

3. The organic acids are volatile and evaporate with water vapor during drying, and can be reused through cooling and recycling.

### BRIEF DESCRIPTION OF THE DRAWINGS

FIG. 1 is a scanning electron microscope morphology of Na₂FeP₂O₇/C material prepared by the organic acid dissolution method in Example 1.

FIG. 2 is charge-discharge curve of a Na₂FeP₂O₇/C electrode prepared by the organic acid dissolution method in Example 1.

FIG. 3 is a scanning electron microscope morphology of bulk material of a Na₄Fe₃(PO₄)₂P₂O₇/C prepared by the organic acid dissolution method in Example 2.

FIG. 4 is charge-discharge curve of a large electrode of Na₄Fe₃(PO₄)₂P₂O₇/C prepared by the organic acid dissolution method in Example 2.

FIG. 5 is a scanning electron microscope morphology of bulk material of a Na₄Fe₃(PO₄)₂P₂O₇/C prepared by the conventional solid phase method in Example 3.

FIG. 6 is charge-discharge curve of a large electrode of a Na₄Fe₃(PO₄)₂P₂O₇/C prepared by the conventional solid phase method in Example 3.

### DETAILED DESCRIPTIONS OF THE EMBODIMENTS

### Example 1

step S1: a mixture of 0.1 mol of metallic iron and 0.2 mol of sodium dihydrogen phosphate was added into a flask;
step S2: 20 ml of formic acid with a mass fraction of 88% was added into the flask, the flask was heated in an oil bath at 90° C., and continuously stirring was performed until the metallic iron was completely dissolved to obtain a pale green liquid;
step S3: 10 g of citric acid was added into the flask and stirred for 10 min, spray-drying was then performed, where an inlet air temperature of a spray dryer was set at 250° C. and the flow rate was 1 L/h, and drying was completed to obtain grey precursor powder; and
step S4: the grey precursor powder was placed in an argon-hydrogen mixed gas atmosphere, where a volume ratio of argon to hydrogen was 95:5, a temperature was heated up to 300° C. at a heating rate of 2° C./min and maintained for 3 h; the temperature was further heated up to 500° C. at a heating rate of 2° C./min and maintained for 10 h, and the temperature was then cooled along with a furnace to room temperature to obtain a polyanion type sodium battery positive electrode material Na₂FeP₂O₇/C.

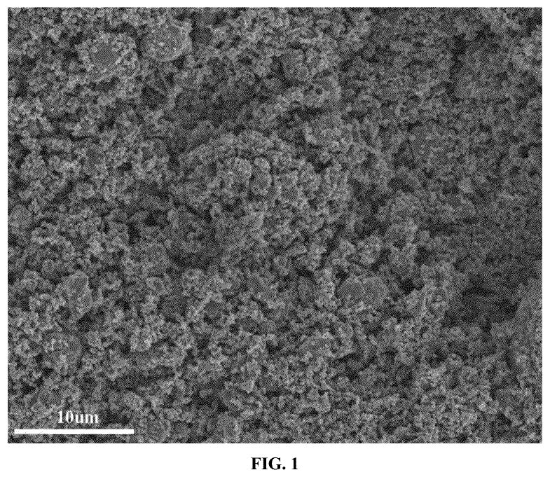

FIG. 1 is a morphology image of the Na₂FeP₂O₇/C, which shows regular spherical particles.

The Na₂FeP₂O₇/C, Surp P and PVDF were uniformly mixed in a mass ratio of 8:1:1 to obtain a mixture, the mixture was coated on aluminum foil using a 200 um four-sided applicator to obtain an electrode film, and the electrode film was dried in a vacuum drying oven at 100° C. for 5 h. The electrode film was punched into a disc with a radius of 0.6 mm using a punching machine, and a CR2016 button cell battery was assembled by using sodium metal as a counter electrode 1 mol/LNaClO₄EC+DEC+EMC (1:1 vol %)+5% FEC as electrolyte, and a PP/PE/PP three-layer separator as a separator.

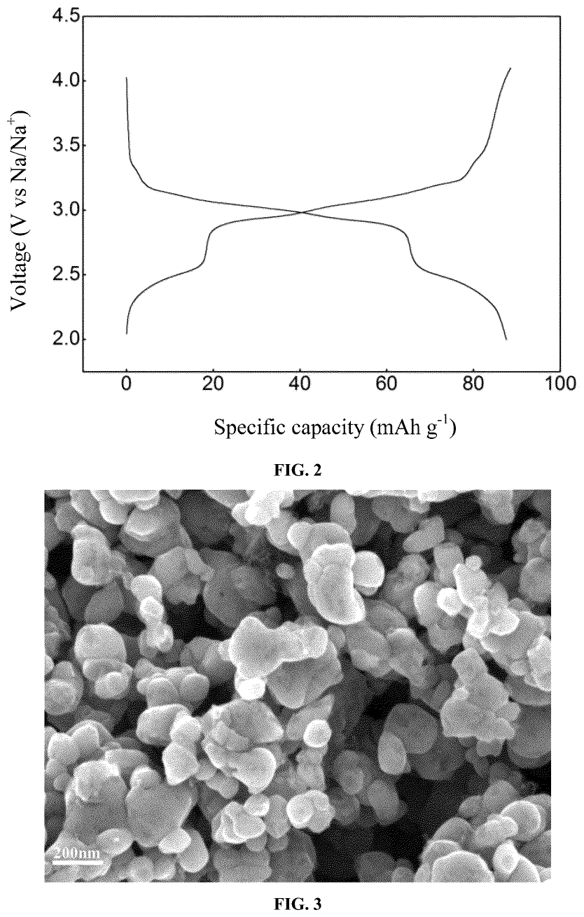

The button cell battery was subjected to a galvanostatic charge-discharge test at a current density of 0.1 C (1 C=97 mAh/g). A test result was shown in FIG. 2. A reversible specific capacity was 90.5 mAh/g over a voltage range of 2.0-4.1 V.

### Example 2

step S1: a mixture of 0.3 mol of metallic iron, 0.2 mol of sodium carbonate and 0.4 mol of phosphoric acid was added into a flask;
step S2: 60 ml of formic acid with a mass fraction of 88% was added into the flask, the flask was heated in an oil bath at 90° C., and continuously stirring was performed until the metallic iron was completely dissolved to obtain a pale green liquid;
step S3: 5 g of glucose was taken and added into the flask, stirred for 10 min, and then dried at 100° C. in a blast air drying oven for 24 h, and drying was completed to obtain grey precursor powder; and
step S4: the grey precursor powder was placed in an argon-hydrogen mixed gas atmosphere, where a volume ratio of argon to hydrogen was 95:5, a temperature was heated up to 200° C. at a heating rate of 5° C./min and maintained for 3 h; the temperature was further heated up to 550° C. at a heating rate of 2° C./min and maintained for 10 h, and the temperature was then cooled along with a furnace to room temperature to obtain a polyanion type sodium battery positive electrode material Na₄Fe₃(PO₄)₂P₂O₇/C.

FIG. 3 is a morphology image of the Na₄Fe₃(PO₄)₂P₂O₇/C, which are secondary particles formed by agglomeration of primary particles, and the particle size is about 200 nm and the distribution is relatively uniform.

The Na₄Fe₃(PO₄)₂P₂O₇/C, acetylene black and PVDF were uniformly mixed in a mass ratio of 8:1:1 to obtain a mixture, the mixture was coated on aluminum foil using a 200 um four-sided applicator to obtain an electrode film, and the electrode film was dried in a vacuum drying oven at 100° C. for 5 h. The electrode film was punched into a disc with a radius of 0.6 mm using a punching machine, and a CR2016 button cell battery was assembled by using sodium metal as a counter electrode 1 mol/L NaClO₄EC+DEC+EMC (1:1 vol %)+5% FEC as electrolyte, and a PP/PE/PP three-layer separator as a separator.

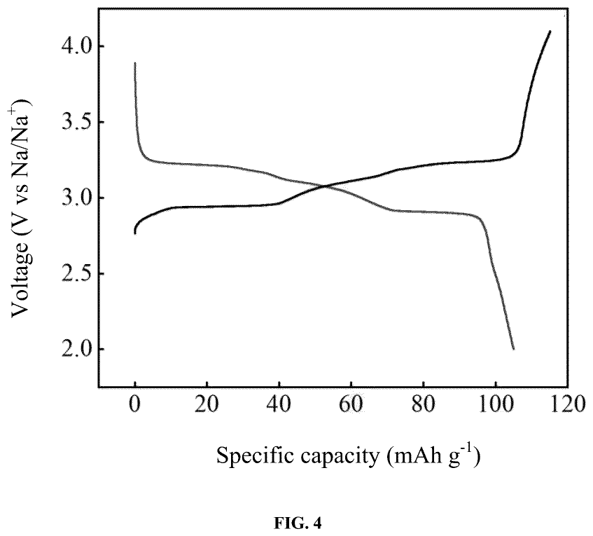

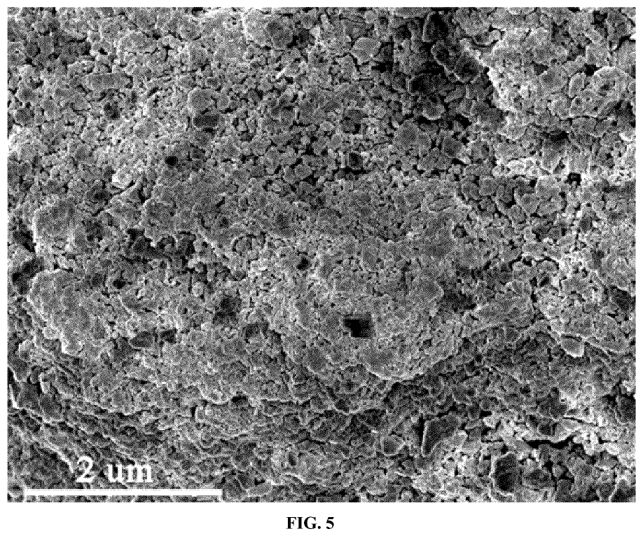

The button cell battery was subjected to a galvanostatic charge-discharge test at a current density of 0.1 C (1 C=129 mAh/g). A test result was shown in FIG. 4. A reversible specific capacity was 105.2 mAh/g over a voltage range of 2.0-4.1 V.

### Example 3

step S1: a mixture of 0.1 mol of sodium pyrophosphate, 0.2 mol of iron phosphate and 0.1 mol of ferrous oxalate was added into a ball milling tank;
step S2: 10 ml of absolute ethanol was added into the ball milling tank, and a mass ratio of ball milling beads to solid raw materials was 20:1;
step S3: 5 g of glucose was taken and added into the ball milling tank, ball milling was started at a rotation speed of 400 r/min and rotated for 5 h, and then dried at 100° C. in a blast air drying oven for 24 h, and upon completion of drying, pale yellow solid powder was obtained; and
step S4: the pale yellow solid powder was placed in an argon-hydrogen mixed gas atmosphere, where a volume ratio of argon to hydrogen was 95:5, a temperature was heated up to 200° C. at a heating rate of 5° C./min and maintained for 3 h; the temperature was further heated up to 550° C. at a heating rate of 2° C./min and maintained for 10 h, and the temperature was then cooled along with a furnace to room temperature to obtain a polyanion type sodium battery positive electrode material Na₄Fe₃(PO₄)₂P₂O₇/C.

FIG. 5 a morphology image of the Na₄Fe₃(PO₄)₂P₂O₇/C, which is an agglomerate with a larger particle size, mainly due to agglomeration of sintered material caused by compaction of the raw materials in the process of ball milling.

The Na₄Fe₃(PO₄)₂P₂O₇/C, acetylene black and PVDF were uniformly mixed in a mass ratio of 8:1:1 to obtain a mixture, the mixture was coated on aluminum foil using a 200 um four-sided applicator to obtain an electrode film, and the electrode film was dried in a vacuum drying oven at 100° C. for 5 h. The electrode film was punched into a disc with a radius of 0.6 mm using a punching machine, and a CR2016 button cell battery was assembled by using sodium metal as a counter electrode 1 mol/L NaClO₄EC+DEC+EMC (1:1 vol %)+5% FEC as electrolyte, and a PP/PE/PP three-layer separator as a separator.

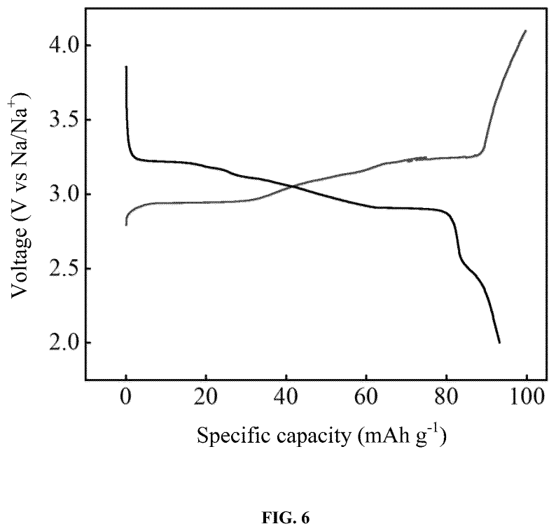

The button cell battery was subjected to a galvanostatic charge-discharge test at a current density of 0.1 C (1 C=129 mAh/g). A test result was shown in FIG. 6. A reversible specific capacity was 93.2 mAh/g over a voltage range of 2.0-4.1 V. Compared with the Na₄Fe₃(PO₄)₂P₂O₇/C prepared by the organic acid dissolution method in Example 2, the material prepared by the solid phase method in Example 3 had a lower capacity, and an obvious small plateau appeared at 2.5V, this was attributed to uneven mixture of local ion in the process of ball milling by the solid phase method, resulting in a small amount of NaFePO₄ or Na₂FeP₂O₇ impurities.

It should be understood that parts not elaborated in the specification fall within the prior art.

The foregoing description of the preferred embodiments has been presented for purposes of illustration and description, and cannot be considered to limit the scope of protection of the present invention. Under the inspiration of the present invention, those skilled in the art can conceive of the substitutions or modifications without departing from the scope of protection of the claims of the present invention, and all the substitutions or modifications should fall within the scope of the present invention. Therefore, the protection scope of the patent for the present invention should be subject to the appended claims.

1. A method for preparing a polyanion type sodium battery positive electrode material on the basis of an organic acid dissolution method, comprising the following steps:
step S1: preparing a mixture of a transition metal source, a sodium source, and a polyanion source, and putting the mixture into a reactor, the transition metal source being a transition metal simple substance or a transition metal oxide
step S2: adding organic acid into the reactor, heating, and continuously stirring until the transition metal source is completely dissolved;
step S3: adding a carbon source, stirring, and drying to obtain precursor powder; and
step S4: heating the precursor powder in an inert gas atmosphere, and after the heating treatment is completed, cooling the precursor powder to room temperature along with a furnace to obtain the polyanion type sodium battery positive electrode material.

2. The method for preparing a polyanion type sodium battery positive electrode material on the basis of an organic acid dissolution method according to claim 1, wherein the transition metal source is V, Ti, Mn, Fe, Co, Ni, Cu, Zn or oxides thereof.

3. The method for preparing a polyanion type sodium battery positive electrode material on the basis of an organic acid dissolution method according to claim 1, wherein the sodium source is one or more of sodium nitrate, sodium carbonate, sodium phosphate, sodium dihydrogen phosphate, sodium formate, sodium acetate, sodium oxalate, sodium citrate and sodium metal.

4. The method for preparing a polyanion type sodium battery positive electrode material on the basis of an organic acid dissolution method according to claim 1, wherein the polyanion source is one or more of phosphorus simple substance, phosphoric acid, pyrophosphoric acid, sodium phosphate, sodium dihydrogen phosphate, boron simple substance, boric acid, sodium borate, silicon simple substance, silicic acid and sodium silicate.

5. The method for preparing a polyanion type sodium battery positive electrode material on the basis of an organic acid dissolution method according to claim 1, wherein the organic acid comprises one or more of formic acid, acetic acid and oxalic acid.

6. The method for preparing a polyanion type sodium battery positive electrode material on the basis of an organic acid dissolution method according to claim 1, wherein usage amounts of the transition metal source, the sodium source and the polyanion source comply with the stoichiometric ratio in the chemical formula of the prepared polyanion type sodium battery positive electrode material, a usage amount of the organic acid is 1-5 times of the molar amount of the added transition metal source, and a usage amount of the carbon source is 1-3 times of the molar amount of the added transition metal source.

7. The method for preparing a polyanion type sodium battery positive electrode material on the basis of an organic acid dissolution method according to claim 1, wherein in the step S2, a heating temperature is 90° C.

8. The method for preparing a polyanion type sodium battery positive electrode material on the basis of an organic acid dissolution method according to claim 1, wherein the carbon source is one or more of graphene, carbon nanotubes, graphite, carbon powder, citric acid, glucose and sucrose.

9. The method for preparing a polyanion type sodium battery positive electrode material on the basis of an organic acid dissolution method according to claim 1, wherein in the step S4, the inert gas atmosphere is argon, nitrogen, argon-hydrogen mixed gas, or nitrogen-hydrogen mixed gas.

10. The method for preparing a polyanion type sodium battery positive electrode material on the basis of an organic acid dissolution method according to claim 1, wherein in the step S4, the heating treatment process is as follows: a temperature is increased to 200° C.-300° C. at a heating rate of 2-5° C./min and then maintained for 3 h; and the temperature is further increased to 400° C.-550° C. at a heating rate of 2° C./min and then maintained for 10 h.
